(19) United States
(12) Patent Application Publication
(10) Pub. No.: US 2009/0189847 A1
(43) Pub. Date: Jul. 30, 2009

(54) CHOLESTERIC LIQUID CRYSTAL DISPLAY DEVICE

(76) Inventors: Christopher John Hughes, Reading (GB); Alan Knapp, Crawley (GB)

Correspondence Address: Pearl Cohen Zedek Latzer, LLP, 1500 Broadway, 12th Floor, New York, NY, 10036, US

(21) Appl. No.: 12/089,942

(22) PCT Filed: Oct. 11, 2006
(86) PCT No.: PCT/GB2006/003778

§ 371 Date: Aug. 7, 2008

(30) Foreign Application Priority Data
Oct. 12, 2005 (GB) 0520763.4

(51) Int. Cl. G09G 3/36; G02F 1/1343

(52) U.S. Cl. 345/103; 349/139

(57) ABSTRACT

A cholesteric liquid crystal display device has a cell comprising a layer of cholesteric liquid crystal material and an active matrix addressing arrangement. The active matrix addressing arrangement is used to drive the liquid crystal material into the planar state and the homeotropic state. To achieve grey levels, the active matrix addressing arrangement is scanned with a plural number of scans (50) in each video period TF and the relative time during which the pixels are driven into the planar and homeotropic states is controlled in accordance with the image data (51, 52).

The present invention relates to a cholesteric liquid crystal display device and its manner of driving to provide an image of relatively high contrast with a range of grey levels, in many applications being a video image.

A cholesteric liquid crystal display device is a type of reflective display device having a low power consumption and a high brightness. A cholesteric liquid crystal display device uses one or more cells each having a layer of cholesteric liquid crystal material capable of being switched between a plurality of states. These states include a planar state being a stable state in which the layer of cholesteric liquid crystal material reflects light with wavelengths in a band corresponding to a predetermined colour. In another state, the cholesteric liquid crystal transmits light which may then be absorbed for example by a rear black layer so that the light is not reflected. A full colour display may be achieved by stacking layers of cholesteric liquid crystal material capable of reflecting red, blue and green light.

The reflective nature of the cholesteric liquid crystal display device provides a degree of brightness in accordance with the ambient lighting. Therefore, a cholesteric liquid crystal display device provides a high brightness in bright conditions, particularly outdoors. In such conditions, the brightness is significantly better than conventional twisted nematic liquid crystal display devices whose brightness is generally limited by the power of a backlight and thus can be difficult to view in bright conditions.

For driving to display an image, the display device typically has an electrode arrangement capable of providing driving of a plurality of pixels across the layer of cholesteric liquid crystal material by respective drive signals.

Most development of cholesteric liquid crystal displays has concentrated on use of the stable states of the liquid crystal material, these being the planar state providing a high reflectance and the focal conic state providing a low reflectance, as well as range of mixture states in which the liquid crystal material has domains in each of the planar and focal conic states providing intermediate reflectances. The use of the stable states provides the advantage of low power consumption as energy is only needed to drive the change of state, whereafter the liquid crystal remains in a stable state displaying an image without consuming power. All current commercially available cholesteric liquid crystal display devices work in this mode of operation.

Despite these advantages of high brightness and low power consumption, it would be desirable to improve the performance in a number of respects.

One desirable feature is to improve the contrast ratio.

Another desirable feature is to allow the display of video image data. To achieve this it is necessary to update the image displayed on the display device repeatedly at a rate sufficient to show a moving image, and preferably at a rate sufficiently high to avoid the perception of flicker created by temporal dither slower than the persistence of vision. The latter effect is usually regarded as requiring the display of at least about 25 frames per second, this corresponding to a video period (after interleaving of two fields to form a frame) of duration 40 ms.

With the aim of displaying video images, a number of documents disclose techniques for achieving near video or fast response addressing of cholesteric liquid crystal display devices with stable state driving of the liquid crystal material. Some examples are as follows.

U.S. Pat. No. 5,661,533 discloses a particular construction of a cell which provides fast switching between the planar and focal conic states of the cholesteric liquid crystal material.

U.S. Pat. No. 5,748,277 discloses a drive scheme for driving pixels of a liquid crystal cell having a passive addressing electrode arrangement into planar and focal conic states.

The related documents US-2001/0,045,946 and WO-02/086855 disclose a cholesteric liquid crystal display device employing an active matrix addressing arrangement to drive pixels of the liquid crystal material into the stable planar and focal conic states with a drive scheme which takes account of whether the state of a pixel needs to be changed.

However, although such techniques improve the rate at which the whole image using planar and focal conic states may be updated, there are typically problems of the type that the update time for each row is too long for acceptable video applications or the use of the reset condition necessary to achieve the required grey levels compromises the perceived contrast ratio.

Furthermore, in general terms, there remains the need to improve the contrast ratio. Whilst use of the stable states provides a display device with a reasonable contrast ratio, the contrast ratio is limited by the fact that the focal conic state scatters light and this has a reflectance of the order of 3-4%.

It has been reported in Nahm, Goda, Min, Chou, Kanicki, Huang, Miller, Sergan, Bos and Doane, “Amorphous Silicon Thin-Film Transistor Active-Matrix Reflective Cholesteric Liquid Crystal Display”, Asia Display 98, pp 979-982 (1998) that a higher contrast ratio can be achieved by use of the homeotropic state of the cholesteric liquid crystal material which has a lower reflectance than the focal conic state. It follows that the use of the homeotropic state as the dark state instead of the focal conic state has the advantages of increasing the contrast ratio and improving the colour gamut. However, expanding on the technical disclosure of this document, there remains the problem of how to drive the liquid crystal material with a range of grey levels, and for many applications at a rate suitable for video images. Nahm et al. discloses the use active matrix addressing to drive 40 rows of pixels with no grey levels and with a frame period of 50 ms, i.e. at a frame rate of 20 Hz. The liquid crystal is driven into the planar or homeotropic state so providing dark and bright states with no intermediate grey levels. Also, the addressing is relatively slow for video display and risks the perception of flicker to a viewer.

A similar disclosure of use of the homeotropic state as a transparent state is present in Kawata, Yamaguchi, Yamaguchi, Akiyama & Suzuki, Materials and Devices Laboratories, Toshiba Corporation, “A High Reflective LCD with Double Cholesteric Liquid Crystal Layers”, SID 97, pp 246-249 (1997).

WO-2004/030335 also discloses driving of a cholesteric liquid crystal display device into the planar and homeotropic states to improve the contrast ratio. However, WO-2004/030335 additionally discloses that grey levels can be achieved by use of temporal modulation. In particular, in each video period a pixel is driven into the planar state and the homeotropic state for relative periods of time which are controlled in accordance with the video image data. As a result of assistance of vision, a viewer perceives an average reflectance of the pixel over the video period. Thus, grey levels are achieved by varying the relative times spent in the planar and homeotropic states. To provide suitable drive signals to the pixels WO-2004/030335 discloses the use of a direct drive electrode arrangement. Thus, the drive electrode of each pixel is driven directly. While this may be implemented easily by the provision of tracks in the same conductive layer as the drive electrodes, it requires relatively wide gaps to be left between the drive electrodes to accommodate all the separate tracks for each drive electrode. Such wide gaps reduce the fill factor which reduces the overall contrast ratio of the display device below the contrast ratio of the liquid crystal material itself. This effect negates some of the contrast ratio improvement provided by use of the homeotropic states. This problem gets more significant as the size of the drive electrodes reduces because the fill factor reduces.

To summarise the above points, it would be desirable to provide a cholesteric liquid crystal display device which has relatively high contrast ratio and which can be driven with a range of grey levels. For many applications it is desirable to drive the display device at a rate suitable for video images.

According to a first aspect of the present invention, there is provided a cholesteric liquid crystal display device, comprising at least one cell comprising:

a layer of cholesteric liquid crystal material; and

an active matrix addressing arrangement comprising:

an array of drive electrodes arranged in lines in two directions, each drive electrode driving a respective portion of the layer of cholesteric liquid crystal material to constitute a respective pixel;

a switch device connected to each drive electrode; and

first and second arrays of addressing lines, respective addressing lines of the first array being connected to the switch devices of respective lines of drive electrodes in a first direction and respective addressing lines of the second array being connected to the switch devices of respective lines of drive electrodes in a second direction so that each switch device is individually addressable by a combination of addressing lines of the first and second arrays, and

the display device further comprising a control circuit operable to apply addressing signals to the addressing lines for controlling driving of the pixels in accordance with video image data updated in successive video periods, wherein

the addressing signals applied to the addressing lines of the first array successively scan the addressing lines of the first array, scanning the entire first array with S scans in each video period, where S is a plural number,

the addressing signals applied to the addressing lines of the second array cause the switch devices connected to each successively scanned addressing line of the first array to apply drive signals to the corresponding drive electrodes which drive the cholesteric liquid crystal material of the corresponding pixels selectively into one of the planar state and the homeotropic state, and

in respect of each pixel, the relative numbers of scans in which the pixel is driven into the planar state and into the homeotropic state in each video period is controlled in accordance with the video image data.

The first aspect of the present invention is therefore concerned with the specific case of a video image.

According to a second aspect of the present invention, there is provided a cholesteric liquid crystal display device, comprising at least one cell comprising:

a layer of cholesteric liquid crystal material; and

an active matrix addressing arrangement comprising:

an array of drive electrodes arranged in lines in two directions, each drive electrode driving a respective portion of the layer of cholesteric liquid crystal material to constitute a respective pixel;

a switch device connected to each drive electrode; and

first and second arrays of addressing lines, respective addressing lines of the first array being connected to the switch devices of respective lines of drive electrodes in a first direction and respective addressing lines of the second array being connected to the switch devices of respective lines of drive electrodes in a second direction so that each switch device is individually addressable by a combination of addressing lines of the first and second arrays, and

the display device further comprising a control circuit operable to apply addressing signals to the addressing lines for controlling driving of the pixels in accordance with image data, wherein

the addressing signals applied to the addressing lines of the first array successively scan the addressing lines of the first array, scanning the entire first array repeatedly,

the addressing signals applied to the addressing lines of the second array cause the switch devices connected to each successively scanned addressing line of the first array to apply drive signals to the corresponding drive electrodes which drive the cholesteric liquid crystal material of the corresponding pixels selectively into one of the planar state and the homeotropic state, and

in respect of each pixel, within each of successive groups of S scans of the addressing lines of the first array, where S is a plural number, the relative numbers of scans in which the pixel is driven into the planar state and into the homeotropic state is controlled in accordance with the image data.

The second aspect of the present invention is concerned with the general case that the image data is static image data representing a static image or is video image data updated in successive video periods.

Thus, the present invention involves driving the cholesteric liquid crystal material of the pixel into the planar and homeotropic states. Such use of the homeotropic state as the dark state allows the contrast ratio to be improved as compared to the use of the stable focal conic state, this being for the same reasons as disclosed in Nahm et al. and discussed above.

In addition, the present invention involves the use of active matrix addressing in a manner which achieves grey levels. Active matrix addressing using an array of drive electrodes, switch devices connected to each drive electrode and two arrays of addressing lines for individually addressing each pixel is a conventional technique to drive known liquid crystal display devices using other liquid crystal effects such as twisted nematic (TN) or vertically aligned nematic (VA or VAN). However, there is an important technical distinction in that grey levels are provided for those known liquid crystals using amplitude modulation by varying the voltage applied to the drive electrode, whereas grey levels cannot be provided by driving cholesteric liquid crystal material in the same manner using amplitude modulation. Therefore, active matrix addressing cannot be directly transferred to cholesteric liquid crystal material for driving using the planar and homeotropic states to achieve grey levels. Indeed Nahm et al. referred to above does disclose the possibility of applying active matrix addressing to cholesteric liquid crystal material but only discloses the possibility of using the planar state as the bright state and the homeotropic state as the dark state without any grey levels in between.

Despite this, the present invention does achieve grey levels. This is by scanning one of the arrays of addressing lines at a high rate. In the case of a video image, the rate is greater than the video rate so that the entire array is scanned with a plural number S of scans in each video period. In the case of a static image, the entire array is scanned repeatedly. Then, the addressing signals applied to the other array drive each pixel into the planar state or the homeotropic state for relative numbers of scans in each successive group of S scans which are controlled in accordance with the image data. In other words, temporal modulation is used in that the periods of time spent by the pixel in the planar and homeotropic states in each successive group of S scans are time modulated by the video image data. The groups of S scans repeat at a rate above the flicker fusion threshold. Due to the persistence of vision, a viewer perceives the pixel as having a reflectance which is the average reflectance over the group of S scans, the perceived reflectance is modulated with the image data. As the relative time spent in the planar and homeotropic states is varied with the image data, the perceived reflectance varies to provide different grey levels.

In applications with a video image, the present invention allows a cholesteric liquid crystal display device to be driven at video rates using the planar and homeotropic states to provide grey levels with a relatively high contrast ratio.

Furthermore, the technique is not limited by the size of the pixels and accordingly is equally applicable to both small and large pixel sizes. As such, the liquid crystal display device could provide images in bright ambient light conditions, particularly outdoors.

Notwithstanding the above advantages, the display device is limited by the speed of the switch devices used in the active matrix addressing arrangement. Such switch devices take a finite time to charge the drive electrode to the required voltage. This puts a lower limit on the time for which addressing signals are applied to each of the addressing lines of the first array during the scan. This puts an upper limit on the number S of scans in each group, which in turn puts an upper limit on the number of grey levels which can be achieved. Despite this limit, the present invention can provide useful products even with the simplest form of active matrix addressing. Products with smaller numbers of pixels in the second direction can achieve higher numbers of grey levels.

To achieve large numbers of grey levels or arrays of pixels a number of further modifications to the active matrix addressing arrangement have been developed, as follows.

A first type of modification is that the first array of addressing lines is divided into N groups of addressing lines, where N is a plural number, the second array of addressing lines comprises N addressing lines in respect of each full line of drive electrodes across the full array of drive electrodes in the second direction, respective ones of the N addressing lines being connected to the switch devices which are connected to the addressing lines of respective ones of the N groups of the first array, and the addressing signals applied to the addressing lines of the first array successively scan the addressing lines of N groups of the first array in parallel.

With this type of modification, the first array of addressing lines is divided into plural groups and the switch devices and drive electrodes connected to each group are connected to separate addressing lines within the second array. This allows each of the plural groups of addressing lines of the first array to be scanned in parallel. This reduces the number of addressing lines which must be successively scanned to address the entire array of drive electrodes. This in turn increases the number S of scans of the entire array which may be performed in each group, thereby increasing the number of grey levels achievable, or conversely allowing an increase in the number of pixels in the display in the second direction.

In general, the manner in which the first array of addressing lines is divided into groups may be done in a variety of ways, but there are two particularly advantageous techniques as follows. The first technique is that the first array of addressing lines is divided into two groups of addressing lines separated in the second direction. In this case, the second array of addressing lines comprises, in respect of each full line of drive electrodes across the full array of drive electrodes in the second direction, two addressing lines extending from opposite sides of the array of drive electrodes in the second direction. This arrangement has the advantage that the two addressing lines extended from opposite sides of the array of drive electrodes do not need to cross, which simplifies the manufacture of the active matrix addressing arrangement.

The second technique is that the first array of addressing lines is divided into two groups of addressing lines. In this case, the second array of addressing lines comprises, in respect of each full line of drive electrodes across the full array of drive electrodes in the second direction, two addressing lines extending on opposite sides of the full line of drive electrodes in the first direction. With this arrangement, there is the advantage that the two addressing lines do not cross because they extend on opposite sides of the line of drive electrodes. This simplifies the manufacture of the active matrix addressing arrangement.

With each of the first and second techniques, the number of scans which may be performed in a group or a video period is doubled. Of course, both of these techniques may be applied in combination in which case the number of scans which may be performed in a group or a video period is quadrupled.

The second modification of the active matrix addressing arrangement is that the drive electrodes are arranged in groups of M adjacent drive electrodes, where M is a plural number, and, in respect of each group of M adjacent drive electrodes, the relative numbers of scans in which the pixels are driven into the planar state and into the homeotropic state in each group of S scans are controlled in combination in accordance with a respective pixel of the image data.

In this case, spatial modulation is used in addition to the temporal modulation in that a group of drive electrodes are controlled in combination in accordance with each respective pixel of the image data. This allows the pixels in each group to be in different states at any given time. The user perceives an average reflectance of the group of pixels over the period of the group of S scans. This provides additional grey levels in respect of each pixel of the image data. For example, if the group of drive electrodes consists of two drive electrodes of equal size, the number of grey levels may be doubled. Alternatively, if the group of drive electrodes consists of two drive electrodes having different areas, the number of grey levels may be increased by a factor greater than two. For example if the areas are in the same ratio as the number G of grey levels achievable from a single pixel, then the number of grey levels is increased by a factor of G.

By combining the two modifications mentioned above, it can be shown that it is possible to provide driving of a cholesteric liquid crystal display device with a sufficient number of pixels in the first direction and a sufficient number of grey levels to provide a good image quality, suitable for example for television images, using switch devices with parameters similar to those currently achievable in active matrix addressing arrangements conventionally employed for other liquid crystal effects. Thus, it can be seen that the present invention can provide a display device suitable for use as a television.

In addition, it is noted that the cholesteric liquid crystal display device may be manufactured separately of the control circuit. Accordingly, in accordance with further aspects of the present invention, there is provided such a cholesteric liquid crystal display device as discussed above in isolation.

To allow better understanding, embodiments of the present invention will now be described by way of non-limitative example with reference to the accompanying drawings, in which:

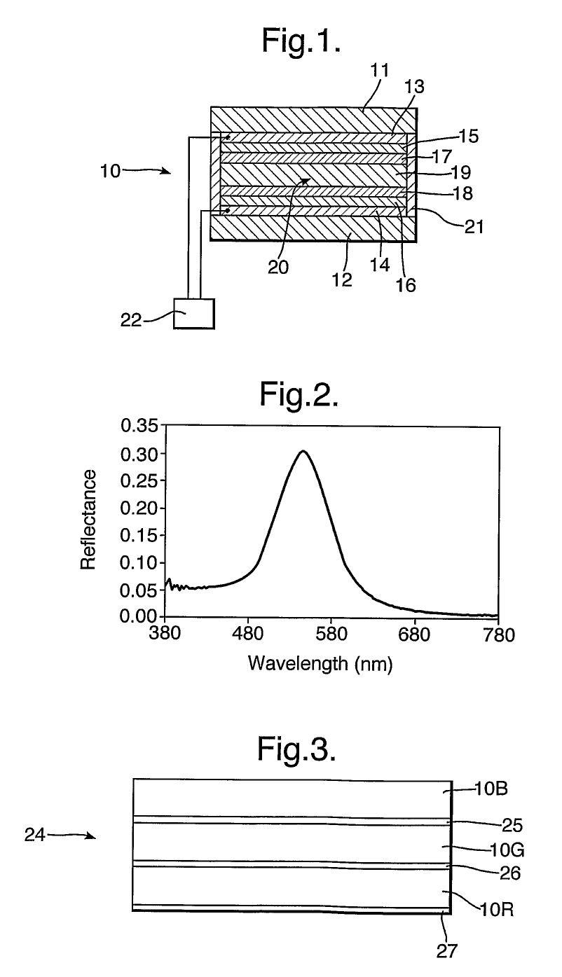

FIG. 1 is a cross-sectional view of a cell of a cholesteric liquid crystal display device;

FIG. 2 is a graph of a typical reflectance spectrum of green cholesteric liquid crystal in the planar state;

FIG. 3 is a cross-sectional view of the cholesteric liquid crystal display device;

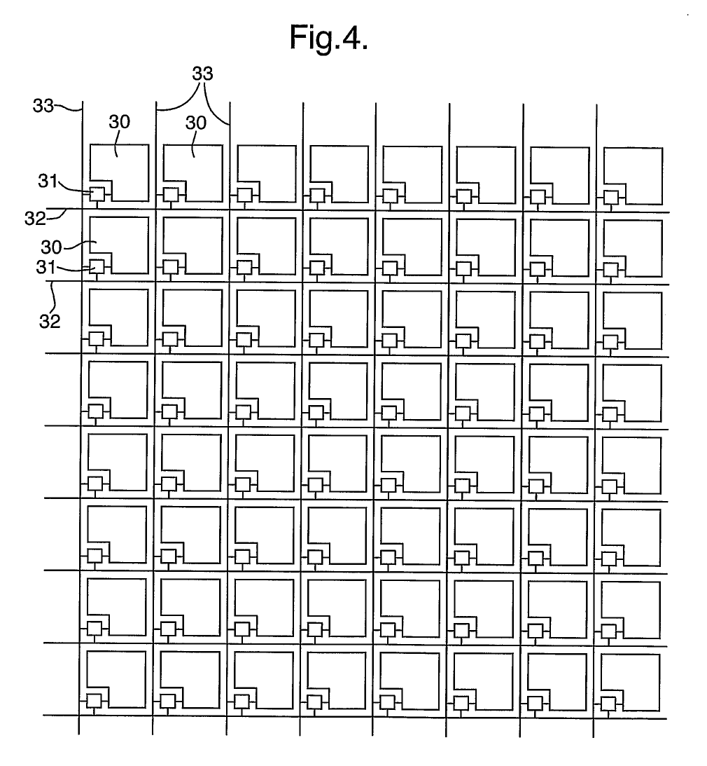

FIG. 4 is a plan view of a part of the active matrix addressing arrangement across several pixels;

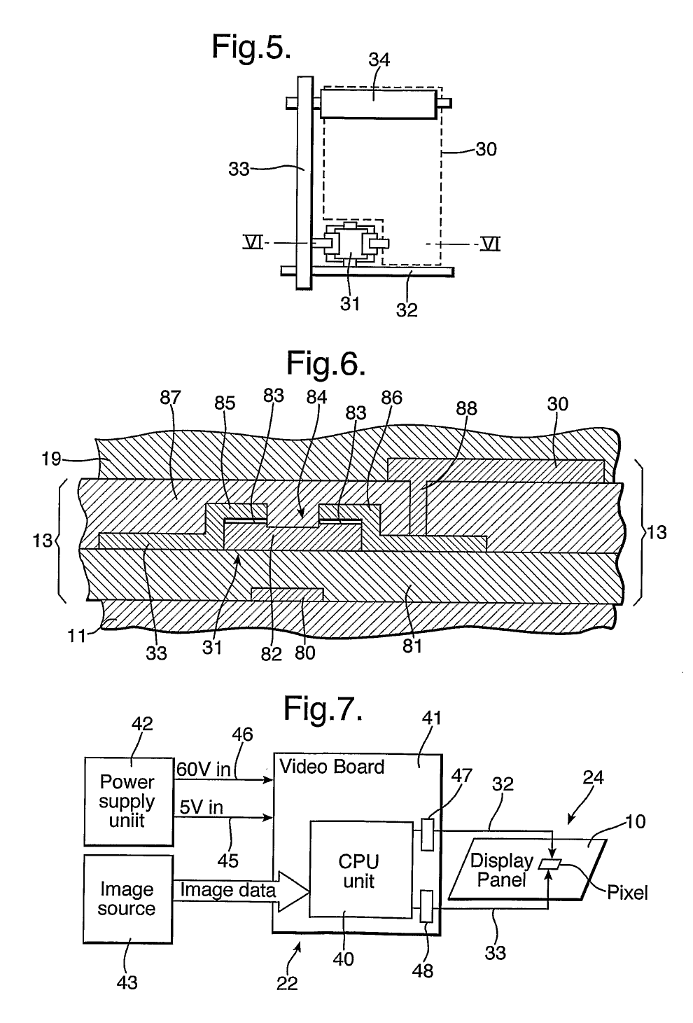

FIG. 5 is a detailed plan view of a part of the active matrix addressing arrangement of a single pixel;

FIG. 6 is a cross-sectional view of the part of the active matrix addressing arrangement of a single pixel shown in FIG. 5, taken along line VI-VI in FIG. 5;

FIG. 7 is a diagram of the control circuit of the display device;

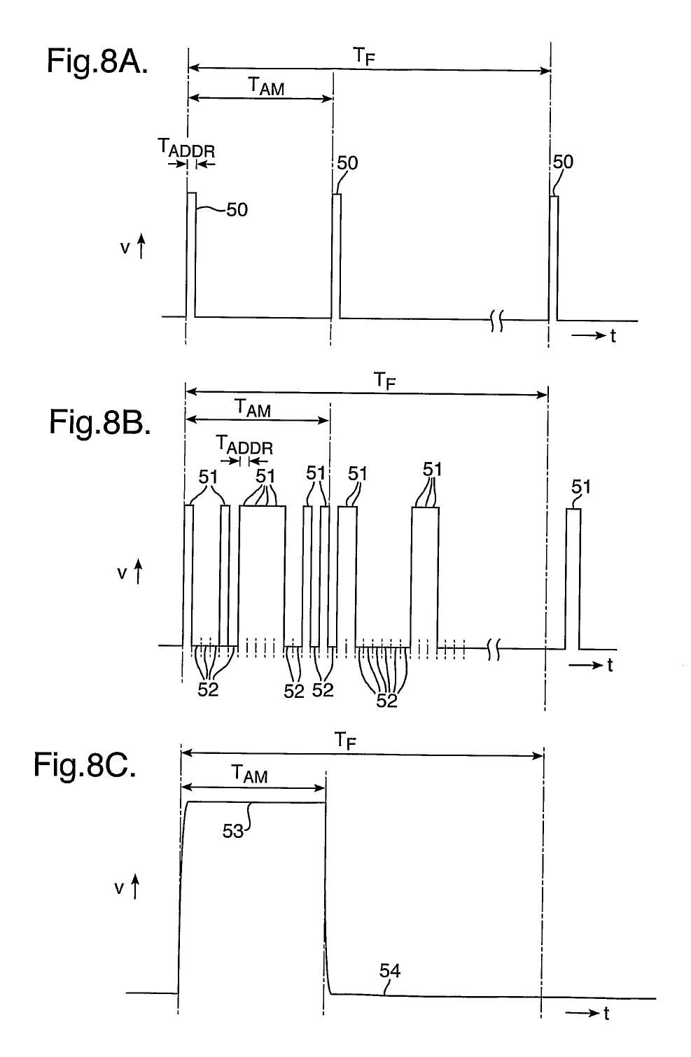

FIGS. 8A to 8C are graphs drawn on the same time scale of the addressing signals and the resultant drive signal on the drive electrodes;

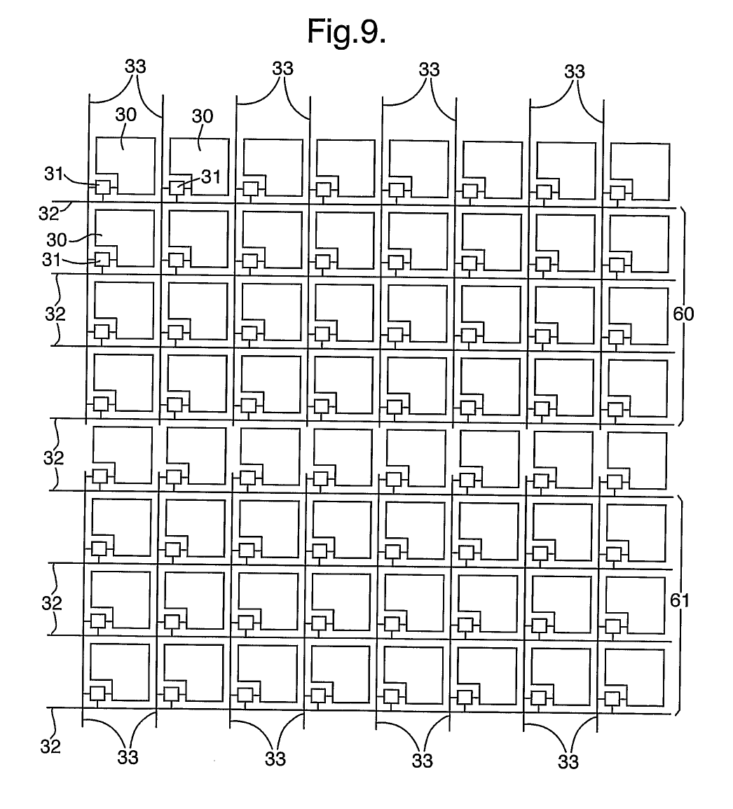

FIG. 9 is a plan view of a part of the active matrix addressing arrangement of a first modified form;

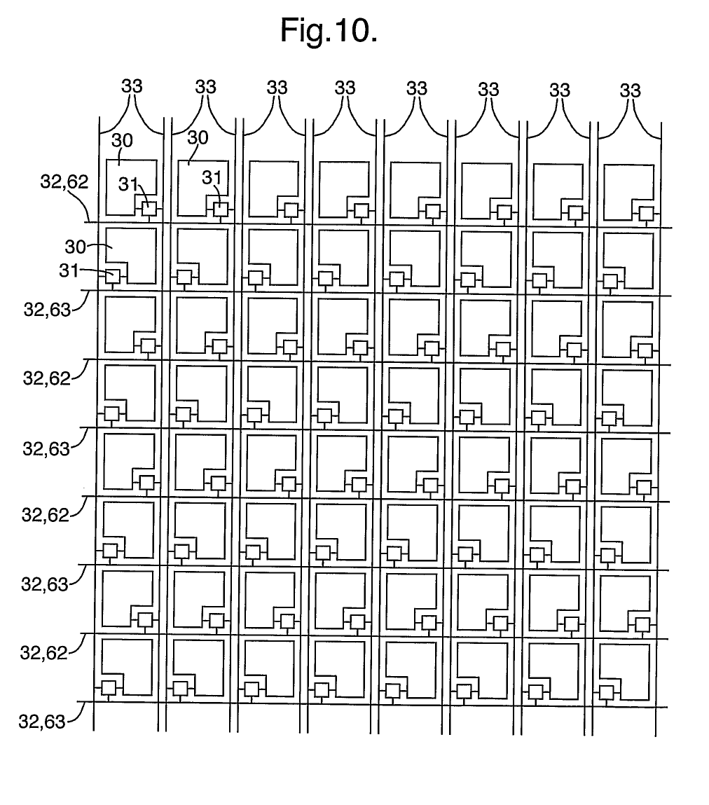

FIG. 10 is a plan view of a part of the active matrix addressing arrangement of a second modified form; and

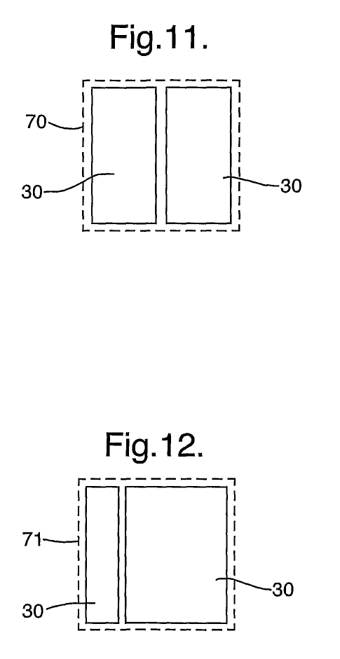

FIGS. 11 and 12 each show a different divided pixel.

FIG. 1 shows a single cell 10 which may be used in the cholesteric liquid crystal display device 24 described further below. The cell 10 has a layered construction, the thickness of the individual layers 11-19 being exaggerated in FIG. 1 for clarity.

The cell 10 comprises two rigid substrates 11 and 12, which may be made of glass or preferably plastic.

The substrates 11 and 12 have, on their inner facing surfaces, respective addressing layers 13 and 14 which provide an active matrix addressing arrangement described in more detail below. The addressing layers 13 and 14 are shown as continuous layers in FIG. 1 for clarity, but in fact at least the addressing layer 13 is formed with various components as described below.

Optionally, each addressing layer 13 and 14 is overcoated with a respective insulation layer 15 and 16, for example of silicon dioxide, or possibly plural insulation layers.

The substrates 11 and 12 define between them a cavity 20, typically having a thickness of 3 μm to 10 μm. The cavity 20 contains a liquid crystal layer 19 and is sealed by a glue seal 21 provided around the perimeter of the cavity 20. Thus the liquid crystal layer 19 is arranged between the addressing layers 13 and 14.

Each substrate 11 and 12 is further provided with a respective alignment layer 17 and 18 formed adjacent the liquid crystal layer 19, covering the respective addressing layer 13 and 14, or the insulation layer 15 and 16 if provided. The alignment layers 17 and 18 align and stabilise the liquid crystal layer 19 and are typically made of polyamide which may optionally be unidirectionally rubbed. Thus, the liquid crystal layer 19 is surface-stabilised, although it could alternatively be bulk-stabilised, for example using a polymer or a silica particle matrix. In this case, the stabilisation is used to optimise the brightness of the planar state.

The liquid crystal layer 19 comprises cholesteric liquid crystal material. Such material has several states in which the reflectivity and transmissivity vary. These states are the planar state, the focal conic state and the homeotropic (pseudo nematic) state, as described in I. Sage, Liquid Crystals Applications and Uses, Editor B Bahadur, vol 3, page 301, 1992, World Scientific, which is incorporated herein by reference and the teachings of which may be applied to the present invention.

In the planar state, the liquid crystal layer 19 selectively reflects a bandwidth of light that is incident upon it. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the liquid crystal layer 19.

The reflectance spectrum of the liquid crystal layer 19 in the planar state is shown in FIG. 2 for the example of reflection of green light. The reflectance spectrum has a central band of wavelengths in which the reflectance of light is substantially constant. This is due to the birefringence of the cholesteric liquid crystal material of the liquid crystal layer 19 and corresponds to reflection of light at different angles relative to the ordinary and extraordinary axes, the light at each angle seeing a different refractive index, which causes a different wavelength λ to be reflected.

Not all the incident light is reflected in the planar state. In a typical full colour display device 24 employing three cells 10, as described further below, the total reflectivity is typically of the order of 30%. The light not reflected by the liquid crystal layer 19 is transmitted through the liquid crystal layer 19. The transmitted light is subsequently absorbed by a black layer 27 described in more detail below.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. The focal conic state is not used by the present display device 24.

In the homeotropic state, the liquid crystal layer 19 is even more transmissive than in the focal conic state, typically having a reflectance of the order of 0.5-0.75%. As light transmitted through the liquid crystal layer is absorbed by the black layer 27 described in more detail below, this state is perceived as darker than the planar state.

The present display device 24 drives the material of the liquid crystal layer 19 selectively into the planar state or the homeotropic state. Use of the homeotropic state as the dark state has the advantage of increasing the contrast ratio, as compared to use of the focal conic state.

The planar state (as well as the focal conic state) is a stable state which persists when no drive signal is applied to the liquid crystal layer 19. However, the homeotropic state is not stable and so maintenance of the homeotropic state requires continued application of a drive signal.

A control circuit 22 supplies signals to the addressing layers 13 and 14 which consequently apply the drive signal across the liquid crystal layer 19 to switch it between the planar and homeotropic states. The actual form of the control circuit 22 and the drive signals are described in more detail below.

FIG. 3 shows the display device 24 which comprises a stack of cells 10R, 10G and 10B, each being a cell 10 of the type shown in FIG. 1 and described above. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 3, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 27 may be formed as a layer of black paint. In use, the black layer 27 absorbs any incident light which is not reflected by the cells 10R, 10G or 10B. Thus when all the cells 10R, 10G or 10B are switched into the homeotropic state, the display device appears black.

The display device 24 is similar to the type of device disclosed in WO-01/88688 which is incorporated herein by reference and the teachings of which may be applied to the present invention.

The addressing layers 13 and 14 are formed as follows to provide an active matrix addressing arrangement for driving a plurality of pixels constituted by regions of the liquid crystal layer 19.

The addressing layer 13 is formed with various components as shown in FIGS. 4 and 5, FIG. 4 being a plan view across several pixels, FIG. 5 being a detailed plan view of the part of the active matrix addressing arrangement in respect of single pixel and FIG. 6 being a cross-sectional view taken along the line VI-VI in FIG. 5. FIG. 4 and the further drawings illustrate only a part of the area of the display device 24 for clarity. In general, the display device 24 may comprise any number of pixels, the structure shown in FIG. 4 and the further drawings being repeated across the display device 24.

The active matrix addressing arrangement comprises an array of drive electrodes 30, each formed of transparent conductive material, typically ITO. The drive electrodes 30 each drive a respective portion of the liquid crystal layer 19 which constitutes a respective pixel. The array of drive electrodes 30 is a two-dimensional, rectangular array. Thus, the drive electrodes 30 are arranged in two directions, horizontally and vertically in FIG. 4. Hereinafter, the horizontal lines of drive electrodes 30 will be referred to as rows and the vertical lines of drive electrodes 30 will be referred to as columns, but this terminology does not imply any particular orientation for the display device 24.

Of course, the drive electrodes 30 could alternatively be arranged in other two dimensional arrays, for example with rows offset from one another, or the drive electrodes 30 could be of other shapes.

The addressing layer 14 is formed as a continuous layer extending across the entire array of drive electrodes 30 and hence across all the pixels, to act as a common electrode.

In principle, the cell 10 may be arranged in the display device 24 with either one of the addressing layers 13 and 14 towards the front, but usually the addressing layer 13 forming the active matrix addressing arrangement is arranged towards the rear.

The addressing layer 13 is formed with a thin-film transistor 31 connected to each drive electrode 30, the drive electrodes 30 being rectangular in shape, except for a cut-out area in which the transistor 31 is situated. The transistor 31 acts as a switch device.

Each thin-film transistor 31 is arranged in the addressing layer 13 as follows. On the surface of the substrate 11 is provided a gate 80 of the transistor 31, the gate being formed from a metal, or other conductor. The gate 80 is covered by a first passivation layer 81 made of an insulating material, typically SiN, and forming part of the addressing layer 13. Formed on the first passivation layer 81 is a body 82 of semiconductor material typically Si, having a doped layer 83 formed on top of the channel 81 with a central recess 84 aligned with the gate 80 and extending through the doped layer 83 to form a channel in the body 82 of semiconductor material through which current flows in operation. Formed over the body 82 of semiconductor material and the doped layer 83 at one end of the channel is a source 85 made of metal, or other conductor. Formed over the body 82 of semiconductor material and the doped layer 83 at the other end of the channel is a drain 85 also made of metal, or other conductor. The transistor 31 is covered by a second passivation layer 87 made of an insulating material, typically SiN, and forming part of the addressing layer 13. The drive electrode 30 is connected to the drain 86 by a contact 88 extending through the second passivation layer 87. The structure of the transistor 31 shown in FIG. 6 is a “bottom-gate” structure but alternatively a “top-gate” structure could be used.

The active matrix addressing arrangement further comprises a first array of addressing lines 32 and a second array of addressing lines 33.

The addressing lines 32 of the first array extend between each row of drive electrodes 30, horizontally in FIG. 4. The addressing line 32 is connected to the gate 80 of every transistor 31 along a respective row of drive electrodes 30. The addressing lines 32 are made of metal, or other conductor, and typically deposited in the same process step as the gates 80 of the transistors 31. Thus, all the transistors 30 along a single row of drive electrodes 30 may be opened and closed by application of an addressing signal on a respective addressing line 32.

The addressing lines 33 of the second array extend between each column of drive electrodes 30, vertically in FIG. 4. The addressing line 33 is connected to the source 85 of every transistor 31 along a respective column of drive electrodes 30. The addressing lines 33 are made of metal, or other conductor, and typically deposited in the same process step as the sources 85 of the transistors 31. Thus, addressing signals applied to the addressing lines 33 charge the drive electrode 30 through any transistor 31 connected thereto which is closed by the addressing signal applied to an addressing line 32 of the first array.

In overview, each transistor 31 is individually addressable by a unique combination of an addressing line 32 of the first array and an addressing line 33 of the second array. The nature of the addressing signals is described further below.

In addition, there is a capacitor 34 connected to each drive electrode 30. The capacitors 34 are also connected to an addressing line 32 of the first array in respect of a different row of drive electrodes 30 from the drive electrode 30 to which the capacitor 34 is connected.

The active matrix addressing arrangement has basically the same construction as is conventional for display devices using other liquid crystal effects such as twisted nematic (TN) or vertically aligned nematic (VA or VAN). The transistors 31 may be amorphous silicon (a-Si) transistors. Thus the active matrix addressing arrangement may be manufactured using conventional techniques. The main modification is that the parameters of the transistors 31 such as the material thicknesses are optimised to charge the drive electrodes 30 with drive signals of a higher magnitude, that is typically of the order of 50-60V as opposed around 5V for twisted nematic liquid crystal material.

Although the active matrix addressing arrangement employs thin-film transistors 31 as switch devices, any other type of switch device could alternatively be used such as a MIM switch.

The control circuit 22 will now be described in more detail. There will first be described the case of display of a video image on the display panel 10.

The control circuit 22 is further illustrated in FIG. 7 in which the first and second arrays of addressing lines 32 and 33 are shown schematically as a single line. The control circuit 22 is formed by a CPU unit 40 mounted on a video board 41 which is a printed circuit board. The video board 41 receives power from a power supply unit 42, in particular a 5V supply 45 which the video board 41 supplies to the CPU unit 40 and a 60V supply 46.

The CPU unit 41 receives video image data representing a video image from an image source 43 and processes it in real time. The video image data is updated in successive video periods at a video rate and is typically in LCD format or LVDS format. The video rate may be changed by the CPU unit 41. In accordance with the video image data, the CPU unit 41 controls row driver circuits 47 to supply addressing signals to the first array of addressing lines 32 and column driver circuits 48 to supply addressing signals to the second array of addressing lines 33. These addressing signals address respective pixels of each of the cells 10R, 10G and 10B and produce a drive signal on the drive electrodes 30 which drives the pixels to cause the display device 24 to display the image by switching the liquid crystal material of each pixel into a state having an appropriate reflectance.

The forms of the addressing signals and the resultant drive signal on the drive electrodes 30 are now described with reference to FIGS. 8A to 8C.

Addressing signals are applied to the addressing lines 32 of the first array to successively scan the addressing lines 32. An example of the addressing signal for a single addressing line 32 is shown in FIG. 8A. The addressing signal takes the form of an addressing pulse 50 of duration T_{ADDR} which is of sufficient magnitude to switch on (i.e. close) all of the transistors 31 connected to the addressing line 32 in question. Outside the addressing pulse 50, the addressing signal is at a low level (typically 0V) which switches off (i.e. opens) the transistors 31 connected to the addressing line 32 in question. Addressing signals of the same form are applied to each addressing line 32 with the pulses staggered to scan each addressing line 32 successively. The pulse is repeated after a period T_{AM} in which the entire first array of addressing lines 32 has been scanned. Thus, taking R as the number of rows of pixels and hence the number of addressing lines 32 in the first array, then

T_{ADDR}≦T_{AM}/R (1)

The entire scan of the first array of addressing lines 32 is repeated to provide a plural number S of scans in each video period T_{F}. Accordingly,

T_{AM}=T_{F}/S (2)

Thus, the duration T_{ADDR} of the addressing pulse is related to the video period by the equation

T_{ADDR}≦T_{F}/(R·S) (3)

Addressing signals are applied to the addressing lines 33 of the second array to address the pixels of each row as it is scanned by the addressing signals applied to the addressing lines 32 of the first array. Thus the addressing signals applied to each addressing line 33 are updated every period of duration T_{ADDR}. The addressing signals applied to each one of the addressing lines 33 take the form of a drive pulse of sufficient magnitude to charge the drive electrode 30, through the transistor 31 which has been closed by the addressing signals applied to the addressing line 32 of the first array, with a drive signal of sufficient magnitude to drive the corresponding pixel into the planar state or into the homeotropic state.

To drive the pixel into the homeotropic state, the desired drive signal on the drive electrode 30 is a drive pulse of relatively high amplitude. To achieve this, the addressing signal applied to the addressing line 32 is a pulse of positive amplitude.

In general, the optimal amplitude of the drive pulse varies in dependence on a number of parameters such the actual liquid crystal material used, the configuration of the cell 10, for example the thickness of the liquid crystal layer 19, and other parameters such as temperature. As is routine in cholesteric liquid crystal display devices, the amplitude can be optimised experimentally for any particular display device 24. Typically, the drive pulse might have an amplitude of 50V to 60V. The addressing signal applied to the addressing line 32 is a pulse of the same amplitude and charges the drive electrode 30 to apply the drive pulse.

To drive the pixel into the planar state, the desired drive signal on the drive electrode 30 is a signal of low amplitude, preferably at or close to 0V. To achieve this, the addressing signal applied to the addressing line 32 is a pulse of such low amplitude.

After the addressing signal applied to a given addressing line of the first array is removed, the transistors 31 connected thereto are closed and the voltage appearing on the drive electrode 30 is maintained by the capacitor 34 connected to the drive electrode 30, thereby maintaining the drive signal across the pixel for the rest of the scan of duration T_{AM}.

An example is shown in FIGS. 8B and 8C. FIG. 8B shows the addressing signal applied to a single addressing line 33 of the second array and includes, in various periods of duration T_{ADDR} in which different rows of pixels are scanned, pulses 51 of high amplitude for charging the respective drive electrodes 30 with a drive pulse for driving the pixel into the homeotropic state and pulses 52 of low amplitude for charging the respective drive electrodes 30 with a drive pulse for causing the pixel to relax into the planar state. FIG. 8C shows the resultant drive signal on a single drive electrode 30 which is addressed by the addressing lines 32 and 33 receiving the addressing signals of FIGS. 8A and 8B, respectively.

In the first scan of duration T_{AM}, while the addressing line 32 of the first array is scanned by the drive pulse 50 of FIG. 8A, the addressing signal applied to the addressing line 33 shown in FIG. 8B is a pulse 51 of high amplitude. This charges the drive electrode 30 to a high voltage which is maintained for the entire scan of duration T_{AM}.

In the second scan of duration T_{AM}, while the addressing line 32 of the first array is scanned by the drive pulse 50 of FIG. 8A, the addressing signal applied to the addressing line 33 shown in FIG. 8B is a pulse 52 of low amplitude. This discharges the drive electrode 30 to a low voltage which is maintained for the entire scan of duration T_{AM}. The net effect is that the drive signal appearing on the drive electrode 30 is a drive pulse 53 which drives the pixel into the homeotropic state in the first scan of duration T_{AM} and a pulse 54 of low amplitude which drives the pixel into the planar state in the second scan of duration T_{AM}.

As shown in FIG. 8C, the drive pulses 53 applied to any given drive electrode are unipolar pulses. In general, it is preferred that the pulses are DC balanced to limit electrolysis of the liquid crystal layer 19 which can degrade its properties over time. Such DC balancing may be achieved by the use of pulses which are of alternating polarity in successive video periods.

The addressing signals applied to the addressing lines 33 of the second array are controlled in respect of the pixels in accordance with the video image data for those pixels. In particular, the addressing signals in respect of a given pixel are controlled over the S scans within a video period so that the relative numbers of scans in which the pixel is driven into the planar and homeotropic states is controlled in accordance with the video image data. The periods of time spent by the pixel in the planar and homeotropic states are time modulated with the video image data. As the video rate is above the flicker fusion threshold, due to the persistence of vision a viewer perceives the pixel as having a reflectance which is the average reflectance over the video period. Thus, the perceived reflectance is modulated with the video image data.

Desirably the duration T_{F} of the video period is sufficiently short to minimise any flicker of the pixels as they alternate between the homeotropic and planar states. The video period is typically at most 50 ms, more preferably at most 30 ms and typically of the order of 20 ms.

As the relative time spent in the planar and homeotropic states is varied, the perceived reflectance varies to provide different grey levels.

In terms of the drive signals on the drive electrodes, the drive scheme has a similar basis to the drive scheme disclosed in WO-2004/030335, the disclosure of which may be applied to the present invention and the contents of which are incorporated herein by reference.

To provide the minimum reflectance, the drive signal on the drive electrode 30 drives the pixel into the homeotropic state for the entire video period so there is no relaxation period. This is not essential and there could be a relaxation period in each video period but this is not preferred as it reduces the number of grey levels and also the minimum reflectance and contrast ratio.

As regards provision of the maximum reflectance, there is a limitation that there is an effective minimum duration for the drive pulse 53 applied to the drive electrode 30 to drive the pixel into the homeotropic state. The effective minimum duration corresponds to the time taken for the cholesteric liquid crystal to undergo a transition from the planar state to the homeotropic state then relaxation back to the planar state. Typically the effective minimum duration is of the order of 2-3 ms. This can be determined experimentally for any given cell 10, the actual value depending on the temperature, the voltage used and the parameters of the cell, such as the thickness of the liquid crystal layer and the properties of the liquid crystal material such as viscosity, elastic constant and dielectric anisotropy. If the drive pulse has a shorter duration than this effective minimum duration, the homeotropic state is not reached and the pixel is driven instead to a stable state which is a mixture of domains in the planar state and domains in the focal conic state. The pixel remains in this stable state and has a reflectance which is lower than the maximum average reflectance achieved by the drive scheme making use of both the homeotropic and planar states.

Accordingly, the duration of the drive pulse 53 applied to the drive electrode 30 to drive the pixel into the homeotropic state is maintained above the effective minimum duration. Where the duration T_{AM} of the scan is greater than the effective minimum duration, this is true even for a single scan. For example for a video period T_{F} of 21 ms, if the number S of scans is 4 or 8 then the duration of a scan is 5.3 ms or 2.6 ms and so above the effective minimum duration for many cells 10. In this case, to achieve the brightest state corresponding to the highest grey level, the pixel is driven into the planar state for the entire video period T_{F}. Thus the number of grey levels including the bright and dark levels is (S+1).

Where the duration T_{AM} of the scan is less than the effective minimum duration, then the drive pulse 53 cannot be as short as a single scan and must be maintained for plural scans. This means it is not possible to achieve reflectances between the reflectance of the planar state and the reflectance of the pixel when driven for the effective minimum duration. Accordingly to maintain linearity in the reflectances of the grey levels, in this case to achieve the brightest state corresponding to the highest grey level, the pixel is not driven into the planar state for the entire video period T_{F} but is instead driven into the homeotropic state for a number of scans sufficient to achieve the minimum effective duration. For example for a video period T_{F} of 21 ms, if the number S of scans is 16 then the duration of a scan is 1.3 ms and the brightest grey level uses a drive pulse of two scans to achieve a minimum effective duration of 2.6 ms. Similarly for a video period T_{F} of 21 ms, if the number S of scans is 32 then the duration of a scan is 0.66 ms and the brightest grey level uses a drive pulse of four scans to achieve a minimum effective duration of 2.6 ms. This has two effects. Firstly, the number of grey levels is reduced to the value (S+1−L) where L is the number of scans required to achieve the minimum effective duration. Secondly, the brightness of the highest grey level is reduced, typically to around 65-70% of the brightness of the planar state. This reduces the contrast ratio of the display device 24 but despite this it is still possible to achieve higher contrast ratios than are achievable by use of driving into the stable focal conic state as the dark state.

The drive signal on a single drive electrode usually consists of a single drive pulse 53 for driving the pixel into the homeotropic state in each video period T_{F}. As an alternative, the drive signal may comprise plural drive pulses 53 for driving the pixel into the homeotropic state in each video period T_{F}, with the limitation that each drive pulse 53 must be longer than the effective minimum duration as described above. Increasing the number of drive pulses 53 in each video period can have the advantage of reducing the perception to the viewer of flicker because the periods of time spent in the homeotropic and planar states reduces relative to the persistence of vision. This must be balanced against the detrimental effect that increasing the number of drive pulses 53 in each video period can change the colour gamut. This effect arises because the relaxation of the pixel from the homeotropic state to the stable planar state is a complex process and proceeds via a metastable transient planar state that has about twice the pitch length of the stable planar state (in fact the pitch of transient planar texture is equal to K33/K22×the pitch of final planar state where K33 is the liquid crystal bend elastic constant and K22 is the twist elastic constant). This is known in itself and is explained for example in D-K Yang & Z-J Lu, SID Technical Digest page 351, 1995 and in J Anderson et al, SID 98 Technical Digest, XX1X page 806, 1998. The increased pitch length means that colour of the reflected light differs while the transient planar state persists, and during the relaxation into the stable planar state changes the colour gamut of the pixel. This effect increases as the number of drive pulses 53 in each video period increases and hence the period of time spent in the transient planar state increases relative to the duration of the video period.

Thus the display device 24 makes use of the homeotropic state as the dark state to provide a high contrast ratio using a driving technique that allows display of video images with plural grey levels. Whilst this is advantageous, the display device 24 is limited by the speed of the transistors 31 which take a finite time to charge the drive electrode 30 to the required voltage. This puts a lower limit on the time T_{ADDR} for which addressing signals are applied to each of the addressing lines 32 of the first array during the scan. For a given video period T_{F} and number R of rows of pixels, this puts an upper limit on the number of scans S and hence the number of grey levels which can be achieved in accordance with equation (3) above. The upper limit on the number of scans is higher if scanning occurs in the direction in which the display has less pixels. This is typically in the row direction, but for some displays it could be the column direction in which case the columns of pixels would be scanned. Despite this limit, it is possible to provide useful products with the simplest form of active matrix addressing.

Products with smaller numbers of pixels in the second direction can achieve higher numbers of grey levels. An example is as follows, based on typical, conservative parameters and giving an indication of what may be achieved with an array mass production manufacturing process similar to that used for current active matrix addressing arrangements for liquid crystal display devices based on other liquid crystal effects. For a given process and design of the transistor 31, further optimisation may well be possible so that better performance can be achieved.

The three key parameters of the transistor 31 are mobility (0.3 cm²/Vs taken here), channel length (6 μm taken here) and metal bus bar, i.e. row/column resistivity (0.2Ω/square taken here). In addition, it is assumed that voltage errors resulting from the pixels not fully charging can be much larger than for current active matrix addressing arrangements for liquid crystal display devices. It is assumed that errors of up to 2V are acceptable. In thin-film transistor design it is difficult to get the pixel voltage to hit the required voltages exactly and some tolerance is allowed. For driving cholesteric liquid crystal material, the tolerance can be quite large as it is only necessary to ensure that the pixel is driven into the homeotropic state. Using these parameters gives a minimum pixel addressing time (i.e. the lower limit on the duration Taddr) of about 12.5 μs. With this charging time possible combinations of number R of rows and number S of scans and hence the number G of grey levels with a typical video period of 21 ms and taking account of the number L of scans required to achieve a typical minimum effective duration of 2 ms to 2.5 ms are set out in the following table.

| | | | | |
|---|---|---|---|---|
| Rows R | 420 | 210 | 105 | 53 |
| Scans S | 4 | 8 | 16 | 32 |
| Grey Levels G | 5 | 9 | 15 | 29 |

There are a number of ways to achieve larger numbers of grey levels or rows of pixels, as follows.

One possibility would be to use an alternative technology for the transistors allowing faster charging of the drive electrodes 30. There are three main switch technologies of thin-film transistors (TFTs): amorphous silicon (a-Si), polycrystalline silicon (p-Si), and single crystal silicon (x-Si). p-Si or x-Si which have higher mobility than a-Si could be used to achieve this, but these materials are expensive.

It is hoped that in the future a printing or coating process to make the transistors 31 will be available to reduce costs. This would eliminate the need for evaporation, photolithography/etching to remove unwanted material deposited in the manufacturing process. Some 4 to 6 steps of this nature are required in the conventional processes which make silicon based transistors expensive. This would allow use of other materials in the transistors 31. However, at present polymer-based transistors that can be deposited by printing into discrete areas (these areas being much larger than can be achieved by etching processes) have much lower mobilities so are unlikely to be useful at the moment. Of course the materials within the transistor 31 are not only the semiconducting component (e.g. silicon) but also conducting and insulating materials with which in printed transistors must also be oriented to take advantage of the low cost printing process. This means that printable conductors and insulators are also required and these must operate with the higher voltages required here. At present such materials are embryonic but if they are developed as hoped then they could be applied to the transistors 31.

Another possibility is to use in-pixel digital circuits. In principle it would be possible to include digital counters or N-to-2^{N} line decoders in a pixel. Digital data corresponding to the required duration of the drive pulse would be loaded onto the counter which would drive the pixel for that period. However, to achieve even 32 levels (5 bits) would require many tens of transistors plus a lot of associated interconnect wiring. It might in principle be possible to fit this into large pixels but this would be unsuitable for small pixels, say of less than 1 mm. This makes the approach unsuitable for consumer type televisions that will require typically require pixels of about 0.5 mm. A further critical issue is that stable transistors are needed to implement such circuits. Only poly-Si can offer the required stability. a-Si transistors or polymer transistors, while suitable for simple AM addressing, are unstable in situations where they are on for long periods and some transistors in these circuits would suffer such conditions. Furthermore CMOS circuits cannot be made in these technologies as they offer only either n or p type transistors, not both. Making the required circuits with NMOS or PMOS would be more complex than in CMOS and the circuits will consume a lot of power.

Another possibility is to use in-pixel analogue circuits. In principle circuits can be designed based on analogue approaches such as charging a capacitor to a variable voltage and allowing it to discharge in a circuit where a transistor switches state once the capacitor voltage reached a certain level, allowing the variable voltage to be converted to a variable time. However such circuits require high levels of uniformity for components such as capacitors (few issues), resistors (a big issue) and transistors (a significant issue). Furthermore the stability problems mentioned above would apply here if such pixels were made with a-Si or polymer transistors.

However, there will now be described two modifications to the active matrix addressing arrangement which are straightforward to implement and which do allow larger numbers of grey levels or rows of pixels to be achieved.

The first type of modification involves splitting the first array of addressing lines 32 into plural groups which are scanned in parallel. This reduces the time T_{AM} taken to scan the entire array and therefore increases the number S of scans which may be fitted within a single video period of duration T_{F}. To achieve this, the second array of addressing lines 33 is modified as compared to the arrangement shown in FIG. 4 to include separate addressing lines 33 connected to each of the groups of addressing lines 32 of the first array. There will now be described two arrangements implementing the first type of modification with a layout of addressing lines which is straightforward to manufacture.

The first arrangement is shown in FIG. 9. The addressing lines 32 of the first array are divided into two groups 60 and 61 separated in the column direction (i.e. separated by a notional dividing line in the row direction), each group 60 and 61 having the same number of addressing lines 32. The addressing lines 33 of the second array are therefore modified as compared to FIG. 4 by dividing in the column direction along the same notional dividing line as between the two groups 60 and 61 of addressing lines 32 of the first array. As a result, the addressing lines 32 of the second array comprise two addressing lines in respect of each line of pixels in the column direction, the two addressing lines extending from opposite sides of the array of drive electrodes 30 in the column direction and each being connected to all the transistors 31 which are connected to one of the groups 60 or 61 of addressing lines 32 of the first array. Although there are additional addressing lines 33 in the second array, since they extend from opposite sides of the array of drive electrodes it is not necessary for the extra addressing lines to cross one another. This makes manufacture simple.

Incidentally, it is possible (additionally or as an alternative) to similarly divide the addressing lines 33 of the second array are divided into two groups separated in the column direction. This would not assist in speeding up the scan but does mean that the rows are half as long so that the charging time is shorter, allowing a larger diagonal display to be achieved for a given resistance of the row metallisation.

The second arrangement is shown in FIG. 10. The addressing lines 32 of the first array are divided into two groups 62 and 63 which are interlaced in the row direction, each group 62 and 63 having the same number of addressing lines 32. The addressing lines 33 of the second array are modified as compared to FIG. 4 by providing two addressing lines 32 in respect of each line of pixels in the column direction, the two addressing lines extending on opposite sides in the row direction of the line of drive electrodes 30 extending in the column direction. Each of the two addressing lines for each column is connected to all the transistors 31 which are connected to one of the groups 62 and 63 of addressing lines 32 of the first array. Although there are additional addressing lines 33 in the second array, since they extend on opposite sides of a column of drive electrodes 30 it is not necessary for the extra addressing lines 33 to cross one another. This makes manufacture simple. The disadvantage of this second arrangement is that it is necessary to provide two addressing lines 33 between each pair of adjacent columns of drive electrodes, thereby increasing the separation of the pixels in the row direction. The adjacent addressing lines 32 also create manufacturing difficulties which could reduce yield if they are too close. The two groups 62 and 63 of addressing electrodes 32 do not need to be interlaced and instead the first array of addressing electrodes 32 could be split in any manner.

With each of the two arrangements in FIGS. 9 and 10, as there are two groups of addressing lines 32 of equal size, the number S of scans which may be fitted within a single video period of duration T_{F} is doubled. For a given minimum pixel addressing time, this allows the product of the number of grey levels and the number of pixels to be approximately doubled (subject to the limitation imposed by the minimum duration of the drive pulse to drive into the homeotropic state).

The manner of dividing the addressing lines 32 in FIGS. 9 and 10 may be combined so that the number S of scans which may be fitted within a single video period of duration T_{F} is quadrupled. For a given minimum pixel addressing time, this allows the product of the number of grey levels and the number of pixels to be approximately quadrupled.

To operate the modified arrangements of FIG. 9 or 10 (or the combination), the two groups 60 and 61 or 62 and 63 (or the four groups in total in the case of the combination) are scanned in parallel by the control circuit. The form of the addressing signals is the same except that addressing signals are simultaneously applied to each group 60 and 61 or 62 and 63. This is straightforward to implement but does require the control circuit 22 to include double (or quadruple in the case of the combination) the number of column driver circuit 48 with corresponding cost increase. It also requires an extra field store to hold the incoming video image data as the groups 60 and 61 or 62 and 63 of addressing lines 32 are driven in parallel so data for each group 60 and 61 or 62 and 63 must be available at the same time.

A second type of modification is to change the arrangement shown in FIG. 4 by splitting the individual pixels in the row direction which are controlled in accordance with a single video pixel into a group of M pixels, where M is two or more. Each pixel in a group has the same addressing arrangement as shown in FIG. 5 so that each pixel in the group may be driven simultaneously. Thus each pixel has its own drive electrode 30 and is addressed by a separate addressing line 33 in the second array. It may thus be considered that the drive electrodes 30 are arranged in groups of M drive electrodes 30.

This modification increases number of drive electrodes and the size of the second array by a factor of M, thereby imposing the same changes on the control circuit 22 as discussed above for the first modification. The individual pixels of the group are sufficiently small that a viewer perceives an average reflectance for the entire group of pixels. This allows a single video pixel of the video image data to be displayed by the group of pixels achieving grey levels using spatial modulation in addition to the temporal modulation discussed above.

Accordingly, the control circuit 22 controls the addressing signals to drive each group of pixels in combination in accordance with a single video pixel of the vide image data. In particular, the addressing signals are controlled over the S scans within a video period so that the relative numbers of scans in which each of the pixels of the group are driven into the planar and homeotropic states is controlled in relation to each other in accordance with a video pixel of the video image data. This increases the number of grey levels which may be achieved because of the combination of spatial modulation and temporal modulation. Thus the group of pixels may be considered as sub-pixels of the video pixel.

Two ways of shaping the drive electrodes 30 and hence the pixels in a single group are shown in FIGS. 11 and 12.

FIG. 11 shows a group 70 of two drive electrodes 30 of equal area. In this case the number of grey levels is doubled. In general with M drive electrodes 30 of equal size the number of grey levels is increased by a factor of M.

FIG. 12 shows a group 71 of two drive electrodes 30 have different areas in a ratio of the number G of grey levels achievable from a single pixel, where G is approximately S or more strictly (S+1−L). In this case, the number of grey levels is increased to a value of G², that is by a factor of G. This is because the full range of grey levels achievable by time modulation of the driving of the smaller pixel may be used in combination with each one of the grey levels achievable by time modulation of the driving of the larger pixel. In general with M drive electrodes 30 of successive sizes in this ratio, the number of grey levels is increased to a value of G^{M}, that is by a factor of G^{(M-1)}.

These ways of shaping the pixels of the group are for illustration and other arrangements with different area ratios might be used. For example, arrangements where “centre of mass” of the brightness does not shift with grey level may well be used in practice.

The second type of modification may be applied in combination with the first type of modification. By applying both the first type of modification splitting the addressing lines 32 into four groups and the second type of modification to achieve an increase in the number of grey levels achievable by a factor of M or G^{(M-1)}, the figures for the number R of rows and the number G of grey levels given in the table above a significant improvement may be achieved. In particular, it can provide display having sufficient resolution and sufficient numbers of grey levels for use as a television, this typically requiring of the order of 400 rows or more and of the order of 64 grey levels, even using a technology for the transistors 31 with parameters similar to those currently achievable with a-Si technology.

Whilst the control circuit 22 is described above in the case of displaying a video image on the display panel, the control circuit 22 can equally be applied to display a static image on the display panel. In the case of a static image, the image data supplied from the image source represents a static image. This means that the image data is not updated in successive video periods. The control circuit 22 operates in basically the same manner as described above except for the following modification taking into account the static nature of the image data.

Instead of the entire scan of the first array of addressing lines 32 being repeated to provide a plural number S of scans in a video period T_{F}, the entire scan of the first array of addressing lines 32 is repeated to provide successive groups of a plural number S of scans in a period T_{F} determined by the control circuit 22. However, the addressing signals applied to the addressing lines 33 of the second array are controlled in respect of the pixels in accordance with the static image data in exactly the same manner as described above within each successive group of S scans. This has the effect that, within each successive group of S scans, the relative numbers of scans in which each pixel is driven into the planar state and into the homeotropic state is varied in accordance with the image data, so that the viewer perceives each pixel as having a reflectance which is the average reflectance over the video period modulated in accordance with the image data. This is equivalent to the control circuit 22 operating as described above with video image data which shows an image which does not change when updated in each video frame.

This effect is achieved by the rate at which the groups of S scans repeat being selected to be above the flicker fusion threshold. This means that the duration T_{F} of a group of S scans is sufficiently short to minimise any flicker of the pixels as they alternate between the homeotropic and planar states. Desirably the duration T_{F} of a group of S scans is at most 50 ms, more preferably at most 30 ms and typically of the order of 20 ms.

1. A cholesteric liquid crystal display device, comprising at least one cell comprising:
a layer of cholesteric liquid crystal material; and
an active matrix addressing arrangement comprising:
an array of drive electrodes arranged in lines in two directions, each drive electrode driving a respective portion of the layer of cholesteric liquid crystal material to constitute a respective pixel;
a switch device connected to each drive electrode; and
first and second arrays of addressing lines, respective addressing lines of the first array being connected to the switch devices of respective lines of drive electrodes in a first direction and respective addressing lines of the second array being connected to the switch devices of respective lines of drive electrodes in a second direction so that each switch device is individually addressable by a combination of addressing lines of the first and second arrays, and
the display device further comprising a control circuit operable to apply addressing signals to the addressing lines for controlling driving of the pixels in accordance with video image data updated in successive video periods, wherein
the addressing signals applied to the addressing lines of the first array successively scan the addressing lines of the first array, scanning the entire first array with S scans in each video period, where S is a plural number,
the addressing signals applied to the addressing lines of the second array cause the switch devices connected to each successively scanned addressing line of the first array to apply drive signals to the corresponding drive electrodes which drive the cholesteric liquid crystal material of the corresponding pixels selectively into one of the planar state and the homeotropic state, and
in respect of each pixel, the relative numbers of scans in which the pixel is driven into the planar state and into the homeotropic state in each video period is controlled in accordance with the video image data.

2. A cholesteric liquid crystal display device according to claim 1, wherein
the first array of addressing lines is divided into N groups of addressing lines, where N is a plural number,
the second array of addressing lines comprises N addressing lines in respect of each full line of drive electrodes across the full array of drive electrodes in the second direction, respective ones of the N addressing lines being connected to the switch devices which are connected to the addressing lines of respective ones of the N groups of the first array, and
the addressing signals applied to the addressing lines of the first array successively scan the addressing lines of N groups of the first array in parallel.

3. A cholesteric liquid crystal display device according to claim 2, wherein the N groups of addressing lines each comprise the same number of addressing lines.

4. A cholesteric liquid crystal display device according to claim 2 wherein
the first array of addressing lines is divided into two groups of addressing lines separated in the second direction,
the second array of addressing lines comprises, in respect of each full line of drive electrodes across the full array of drive electrodes in the second direction, two addressing lines extending from opposite sides of the array of drive electrodes in the second direction.

5. A cholesteric liquid crystal display device according to claim 4,
wherein
the two groups of first array of addressing lines are each further divided into two groups of addressing lines,
the second array of addressing lines comprises, in respect of each full line of drive electrodes across the full array of drive electrodes in the second direction, four addressing lines, two of the addressing lines extending from each side of the array of drive electrodes in the second direction on opposite sides of the full line of drive electrodes in the first direction.

6. A cholesteric liquid crystal display device according to claim 2, wherein
the first array of addressing lines is divided into two groups of addressing lines,
the second array of addressing lines comprises, in respect of each full line of drive electrodes across the full array of drive electrodes in the second direction, two addressing lines extending on opposite sides of the full line of drive electrodes in the first direction.

7. A cholesteric liquid crystal display device according to claim 6, wherein the two groups of addressing electrodes are interlaced in the second direction.

8. A cholesteric liquid crystal display device according to claim 1, wherein the drive electrodes are arranged in groups of M adjacent drive electrodes, where M is a plural number, and, in respect of each group of M adjacent drive electrodes, the relative numbers of scans in which the pixels are driven into the planar state and into the homeotropic state in each video period are controlled in combination in accordance with a respective video pixel of the video image data.

9. A cholesteric liquid crystal display device according to claim 8, wherein the M adjacent drive electrodes of each group have the same area.

10. A cholesteric liquid crystal display device according to claim 8, wherein the M adjacent drive electrodes have different areas.

11. A cholesteric liquid crystal display device according to claim 1, wherein the array of drive electrodes has a lesser number of drive electrodes in said first direction than in said second direction.

12. A cholesteric liquid crystal display device according to claim 1, wherein the video period is no more than 50 ms.

13. A cholesteric liquid crystal display device according to claim 1, wherein the first array of addressing lines are connected to control opening and closing of the switch devices, the addressing signals applied to the addressing lines of the first array successively scan the addressing lines of the first array to close the switch devices connected to each successively scanned addressing line of the first array, and the addressing signals applied to the addressing lines of the second array charge, through the closed switch devices connected to each successively scanned addressing line of the first array, the corresponding drive electrodes with said drive signals.

14. A cholesteric liquid crystal display device according to claim 1, wherein the switch devices are thin film transistors.

15. A cholesteric liquid crystal display device according to claim 14, wherein the first array of addressing lines are connected to the gates of the thin film transistors and the second array of addressing lines are connected to the sources of the thin film transistors.

16. A cholesteric liquid crystal display device according to claim 1, wherein the active matrix addressing arrangement further comprises a capacitor connected to each drive electrode.

17. A cholesteric liquid crystal display device according to claim 1, wherein the control circuit comprises driver circuits connected to the first and second arrays of addressing lines to apply the addressing signals and a digital controller arranged to control the driver circuits to apply the addressing signals.

18. A cholesteric liquid crystal display device, comprising at least one cell comprising:
a layer of cholesteric liquid crystal material; and
an active matrix addressing arrangement comprising:
an array of drive electrodes arranged in lines in two directions, each drive electrode driving a respective portion of the layer of cholesteric liquid crystal material to constitute a respective pixel;
a switch device connected to each drive electrode; and
first and second arrays of addressing lines, respective addressing lines of the first array being connected to the switch devices of respective lines of drive electrodes in a first direction and respective addressing lines of the second array being connected to the switch devices of respective lines of drive electrodes in a second direction so that each switch device is individually addressable by a combination of addressing lines of the first and second arrays, and
the display device further comprising a control circuit operable to apply addressing signals to the addressing lines for controlling driving of the pixels in accordance with image data, wherein
the addressing signals applied to the addressing lines of the first array successively scan the addressing lines of the first array, scanning the entire first array repeatedly,
the addressing signals applied to the addressing lines of the second array cause the switch devices connected to each successively scanned addressing line of the first array to apply drive signals to the corresponding drive electrodes which drive the cholesteric liquid crystal material of the corresponding pixels selectively into one of the planar state and the homeotropic state, and
in respect of each pixel, within each of successive groups of S scans of the addressing lines of the first array, where S is a plural number, the relative numbers of scans in which the pixel is driven into the planar state and into the homeotropic state is controlled in accordance with the image data.

19. A cholesteric liquid crystal display device according to claim 18, wherein said image data is static image data representing a static image.

20. A cholesteric liquid crystal display device according to claim 19, wherein the period of a group of S scans is no more than 50 ms.

21. A cholesteric liquid crystal display device according to claim 18, wherein
said image data is video image data updated in successive video periods,
the addressing signals applied to the addressing lines of the first array successively scan the addressing lines of the first array, scanning the entire first array with S scans in each video period, where S is a plural number, and
in respect of each pixel, within the S scans of the addressing lines of the first array in each video period, the relative numbers of scans in which the pixel is driven into the planar state and into the homeotropic state is controlled in accordance with the image data in the respective video period.

22. A cholesteric liquid crystal display device according to claim 21, wherein the video period is no more than 50 ms.

23. A cholesteric liquid crystal display device according to claim 18, wherein
the first array of addressing lines is divided into N groups of addressing lines, where N is a plural number,
the second array of addressing lines comprises N addressing lines in respect of each full line of drive electrodes across the full array of drive electrodes in the second direction, respective ones of the N addressing lines being connected to the switch devices which are connected to the addressing lines of respective ones of the N groups of the first array, and
the addressing signals applied to the addressing lines of the first array successively scan the addressing lines of N groups of the first array in parallel.

24. A cholesteric liquid crystal display device according to claim 23, wherein the N groups of addressing lines each comprise the same number of addressing lines.

25. A cholesteric liquid crystal display device according to claim 23, wherein
the first array of addressing lines is divided into two groups of addressing lines separated in the second direction,
the second array of addressing lines comprises, in respect of each full line of drive electrodes across the full array of drive electrodes in the second direction, two addressing lines extending from opposite sides of the array of drive electrodes in the second direction.

26. A cholesteric liquid crystal display device according to claim 25, wherein
the two groups of first array of addressing lines are each further divided into two groups of addressing lines,
the second array of addressing lines comprises, in respect of each full line of drive electrodes across the full array of drive electrodes in the second direction, four addressing lines, two of the addressing lines extending from each side of the array of drive electrodes in the second direction on opposite sides of the full line of drive electrodes in the first direction.

27. A cholesteric liquid crystal display device according to claim 23, wherein
the first array of addressing lines is divided into two groups of addressing lines,
the second array of addressing lines comprises, in respect of each full line of drive electrodes across the full array of drive electrodes in the second direction, two addressing lines extending on opposite sides of the full line of drive electrodes in the first direction.

28. A cholesteric liquid crystal display device according to claim 27, wherein the two groups of addressing electrodes are interlaced in the second direction

29. A cholesteric liquid crystal display device according to claim 18, wherein the drive electrodes are arranged in groups of M adjacent drive electrodes, where M is a plural number, and, in respect of each group of M adjacent drive electrodes, the relative numbers of scans in which the pixels are driven into the planar state and into the homeotropic state, within each of successive group of S scans of the addressing lines of the first array, are controlled in combination in accordance with a respective pixel of the image data.

30. A cholesteric liquid crystal display device according to claim 29, wherein the M adjacent drive electrodes of each group have the same area.

31. A cholesteric liquid crystal display device according to claim 30, wherein the M adjacent drive electrodes have different areas.

32. A cholesteric liquid crystal display device according to claim 18, wherein the array of drive electrodes has a lesser number of drive electrodes in said first direction than in said second direction.

33. A cholesteric liquid crystal display device according to claim 18, wherein the first array of addressing lines are connected to control opening and closing of the switch devices, the addressing signals applied to the addressing lines of the first array successively scan the addressing lines of the first array to close the switch devices connected to each successively scanned addressing line of the first array, and the addressing signals applied to the addressing lines of the second array charge, through the closed switch devices connected to each successively scanned addressing line of the first array, the corresponding drive electrodes with said drive signals.

34. A cholesteric liquid crystal display device according to claim 18, wherein the switch devices are thin film transistors.

35. A cholesteric liquid crystal display device according to claim 34, wherein the first array of addressing lines are connected to the gates of the thin film transistors and the second array of addressing lines are connected to the sources of the thin film transistors.

36. A cholesteric liquid crystal display device according to claim 18, wherein the active matrix addressing arrangement further comprises a capacitor connected to each drive electrode.

37. A cholesteric liquid crystal display device according to claim 18, wherein the control circuit comprises driver circuits connected to the first and second arrays of addressing lines to apply the addressing signals and a digital controller arranged to control the driver circuits to apply the addressing signals.

38. A cholesteric liquid crystal display device, comprising
at least one cell comprising:
a layer of cholesteric liquid crystal material; and
an active matrix addressing arrangement comprising:
an array of drive electrodes arranged in lines in two directions, each drive electrode driving a respective portion of the layer of cholesteric liquid crystal material to constitute a respective pixel;
a switch device connected to each drive electrode; and
first and second arrays of addressing lines, respective addressing lines of the first array being connected to the switch devices of respective lines of drive electrodes in a first direction and respective addressing lines of the second array being connected to the switch devices of respective lines of drive electrodes in a second direction so that each switch device is individually addressable by a combination of addressing lines of the first and second arrays,
wherein
the first array of addressing lines is divided into N groups of addressing lines, where N is a plural number,
the second array of addressing lines comprises N addressing lines in respect of each full line of drive electrodes across the full array of drive electrodes in the second direction, respective ones of the N addressing lines being connected to the switch devices which are connected to the addressing lines of respective ones of the N groups of the first array, and
the addressing signals applied to the addressing lines of the first array successively scan the addressing lines of N groups of the first array in parallel.

39. A cholesteric liquid crystal display device according to claim 38, wherein
the first array of addressing lines is divided into two groups of addressing lines separated in the second direction,
the second array of addressing lines comprises, in respect of each full line of drive electrodes across the full array of drive electrodes in the second direction, two addressing lines extending from opposite sides of the array of drive electrodes in the second direction.

40. A cholesteric liquid crystal display device according to claim 39, wherein
the two groups of first array of addressing lines are each further divided into two groups of addressing lines,
the second array of addressing lines comprises, in respect of each full line of drive electrodes across the full array of drive electrodes in the second direction, four addressing lines, two of the addressing lines extending from each side of the array of drive electrodes in the second direction on opposite sides of the full line of drive electrodes in the first direction.

41. A cholesteric liquid crystal display device according to claim 38, wherein
the first array of addressing lines is divided into two groups of addressing lines,
the second array of addressing lines comprises, in respect of each full line of drive electrodes across the full array of drive electrodes in the second direction, two addressing lines extending from the same side of array of drive electrodes in the second direction on opposite sides of the full line of drive electrodes in the first direction.

42. A cholesteric liquid crystal display device according to claim 41, wherein the two groups of addressing electrodes are interlaced in the second direction.

43. (canceled)

44. (canceled)

45. (canceled)

46. A cholesteric liquid crystal display device according to claim 38, wherein the array of drive electrodes has a lesser number of drive electrodes in said first direction than in said second direction.

47. A cholesteric liquid crystal display device according to claim 38, wherein the first array of addressing lines are connected to control opening and closing of the switch devices, and the first array of addressing lines are connected to charge the drive electrodes through the switch devices when closed.

48. A cholesteric liquid crystal display device according to claim 38, wherein the switch devices are thin film transistors.

49. A cholesteric liquid crystal display device according to claim 48, wherein the first array of addressing lines are connected to the gates of the thin film transistors and the second array of addressing lines are connected to the sources of the thin film transistors.

50. A cholesteric liquid crystal display device according to claim 38, wherein the active matrix addressing arrangement further comprises a capacitor connected to each drive electrode.
